(19) United States
(12) Patent Application Publication
(10) Pub. No.: US 2018/0222466 A1
(43) Pub. Date: Aug. 9, 2018

(54) SHIP (VARIANTS)

(71) Applicant: Gtvorg Seroshaevih NOROYAN, s. Anuchino (RU)

(72) Inventor: Gtvorg Seroshaevih NOROYAN, s. Anuchino (RU)

(21) Appl. No.: 15/746,588

(22) PCT Filed: Jul. 20, 2016
(86) PCT No.: PCT/RU2016/000461

§ 371 Date: Jan. 22, 2018

(30) Foreign Application Priority Data
Jul. 23, 2015 (EA) 201500692

(51) Int. Cl. B60V 3/06; B63B 1/38

(52) U.S. Cl. CPC B60V 3/06; B60V 1/18; B63B 1/38

(57) ABSTRACT

The invention relates to shipbuilding and can be used in reconditioning in order to economize fuel and to increase speed. The technical problem is solved by the shipboard installation of air compressors, air receiver tanks, pass valves, air conduits, air separating conduits, air intakes and air injectors, which are interconnected by air ducts. An air separating conduit is mechanically secured in the bow of the ship and has air injectors secured along the centre thereof up to the stern. The injectors direct a jet of air backwards so that the jet of air thrusts the ship forwards, then the air rises along the sides of the ship, maintaining a layer of air between the ship and the water, thus reducing water resistance. The injectors in the bow direct a jet of air such that the ship is constantly sailing into an air space.

### CROSS REFERENCE TO RELATED APPLICATIONS

The present application is a National stage application from PCT application PCT/RU2016/000461 filed on Jul. 20, 2016, which claims priority to Eurasian patent application No. 201500692 filed on Jul. 23, 2015.

### FIELD OF INVENTION

The invention relates to the field of shipbuilding and can be used in modernization for fuel economy and increase of speed.

### BACKGROUND

Until now, various types of sea ships have been built based on the same principle: an elongated hull with a sharp bow in order to reduce the resistance to minimum during the travel by water.

The prior art discloses a ship (U.S. Pat. No. 7,997,221 B2, 16 Aug. 2011) which allows reducing water resistance by placing air bubbles between the hull and the water flow during the travel. The ship contains an air compressor, a flow control valve, an air intake and an air duct.

Also, the prior art discloses a ship (US 2011259257 A1, 27 Oct. 2011), which also makes it possible to reduce water resistance by placing air bubbles between the hull and the water flow during the travel. The ship contains an air compressor, valves, an air intake, an air duct and an air separation duct. The specified source of information is selected as a prior art.

The drawback of these ships is the significant resistance of water during the travel, which was not possible to suppress. The proposed technical solution makes it possible to reduce water resistance.

### SUMMARY

The technical task is solved by installing air compressors, receivers, flow control valves, air ducts, air separation ducts, air intakes and air injectors on the ship.

Internal air ducts are designed to connect the compressor to the air separation duct and air intakes.

The air separation duct is mechanically fixed in the part of the ship that is below the waterline, beginning from the bow and extending to the bottom of the ship, and then passing along the bottom of the ship to the aft part.

The air separation duct can be made as a one single piece or can consist of separate parts separately connected to receivers; If required, they can be installed on other parts of the ship, alongside below the waterline.

The air separation duct can be located both outside the ship and inside it; the duct shall be mechanically fixed on the bottom and on the bow part. The duct may also be a built-in element.

The air injectors are installed on the air separation duct, whether as one row in the middle or as two rows for each side separately. Injectors differ by size and can be self-regulating in any known way in order to change the direction of injection.

The injectors direct the air jet backward or backward with a slight incline downwards so the jet of air pushes the ship forward, and then the air bubbles along the sides of the ship rise thus creating a layer of air between the ship and the water, which significantly reduces the resistance of water influencing the ship travel.

At the bow part, the injectors direct the air jet downward or backward with a slight incline, depending on the tilt of the bow part of the ship in order to create the air space in front of the ship by the moment the ship moves in there by the bow part to suppress the water resistance from the front part of the ship, and in a way that the air could then rise alongside of the ship.

In the bow part of the ship, the air is supplied in an amount sufficient to allow the ship to get rid of touching the water from the front side.

If required, the air separation duct with injectors can be installed in other parts of the ship in a way that after venting the air could be directed backward and downward at an angle, and then it could be rising up by the sides of the ship. Other air jet injectors shall be directed to the water under the ship or alongside of the ship.

The amount of air being ejected from under the ship tends to rise upward influenced by the pressure of water and has the potential energy that can be used as an auxiliary force for ship travel.

Air ducts are mechanically fixed outside along the sides of the ship. The ducts are tilted upward on the rear side, so that the air could flow upward and backward directed by the ducts, and the air ducts can also be built in the hull of the ship.

The movement of air backward and upward along the duct helps the ship to move forward and works as an air cushion for the ship.

The number of ducts and the slope of the ducts to the horizontal is different and can be calculated in each case separately to obtain the maximum efficiency. Air ducts are installed, beginning from the bottom of the ship and up to the waterline.

The outside ducts are made of a flat or spherical profile that is mechanically attached to the sides of the ship, sloping downwards to form an air duct.

The air ducts can be cut into the hull of the ship in the form of a metal corner from the inside in a way to form a duct between the side and the upper side of the said corner to pass the air through, and the opening of corresponding is cut in the sides of the ship in a way that the air rising through the sides of the ship through the opening could enter the duct and could be ejected through it upward and backward.

External air ducts can be long, beginning from the bottom of the ship and going to the top, and can also be fragmented and be fixed on the ship in different ways depending on the specific situation.

For each ship, the number and slope of the ducts are calculated individually and at different heights of the ship, the ducts can be installed under different slopes and be made of different lengths.

The air ducts are installed in a way that the air from the lower duct, while rising up, could enter into the next duct, located above, and so on in turn until the end, when the air rises to the water surface. The air ducts can be straight and arched or of any other known shape, and they shall be set in horizontal rows on the sides of the ship, the distance between the rows is also different: if the outside air ducts are surface-mounted, they are installed in a way that the front ones cover the next ones and so on to the aft part (in the shape of half-open and bent downward fish scales).

When the rows are immediately adjacent to each other, the upper row covers the lower row.

Initially, the air is supplied to each air duct in an excessive amount so the air could immediately start to rise not only by the duct, but also part of the excess air could pass through the sidewalls of the ducts and in turn could pass all the air ducts located above.

Also for the passage of part of the air upwards, the air ducts are narrowed so that the air could gradually pass through the sidewalls of the air ducts and maintain an air layer between the water and the ship hull. The degree of narrowing depends on the specific situation, taking into consideration the following parameters: the amount of air supplied, the slope of the ship sides at this place, the width of the air ducts, the distances between the ducts along the vertical and the horizontal axis and the average travel speed of the ship.

The air ducts from the bow part are wider and lower than the rear ones (figure No. 3).

On the aft part, at the rear side, the air ducts are installed horizontally or with different slopes. It is also feasible to build a ship with a proper slope of the rear side and the air jet could put pressure on it, and the ship could travel straight ahead, the slope of the air ducts on the rear side is different and could be regulated at different speeds by any known method. The air ducts are made of sheet metal and are of different configurations.

The ship is to be equipped with air intakes, which are connected by air ducts to the compressor and are installed at the bow part above the waterline on the sides. The air intakes are installed in a way that the air could be pumped from the bow part of the ship, and the pumping could covers the entire volume of air that meets the ship travelling at any speed in order to provide tractive power for travelling ahead and to suppress the counter wind resistance. Air intakes can be of different types, and can be installed in different orders.

The equipment of the ship with a lot of air injectors, air ducts and air intakes from all sides provides the following advantages:

the air jet from the injectors pushes the ship forward;
the part of water resistance is suppressed due to the air layer;
the ship remains air-cushioned and is lighter;
the ship is lighter due to the pushing force of the air jet supplied by the air injector from the front part and due to the air that presses the rear side upwards;.
the air intakes suppress the resistance of the oncoming air generating a pull force in forward direction;
the air from outside air ducts pushes the ship forward;
the ship always travels into the airspace with its bow part;
the air rises on sides and pulls the ship upward;
the air from the rear presses the rear side and pushes the ship forward.

The air ducts can be of different configurations, namely of semi-circular, angular, or of any other configuration. The air ducts can be built into the hull of the ship, and the ship can be built considering its appropriate profile, and the air ducts can be adjustable by their slope according the horizontal axis in any known way o configuration. The width and the length of the ducts are also different and depend on the specific situation.

The air is supplied under the ship in a way partially allowing the ship not to touch water (marked by lines and dots).

During the travel of the ship, the air lines and bubbles move between the ship hull and water and broke up and spread throughout the exterior surface of the ship, reducing the water resistance to a minimum. In order to use the potential air force that is supplied to the ship more effectively, the ship is designed with the upper part being much wider in the water (figure No. 5) such that the air could stay longer under the ship. The longer the way of air alongside the ship, the greater the efficiency of the displacing force of water that pushes out the air under the ship, and the air in turn presses on the air ducts and pushes the ship forward.

The air ducts of the upper row (under the waterline) are constructed in a way to direct air emerging from the water backward to push the ship forward, and before emerging direct the air backward and upward, to increase the travel speed.

For high-speed ships, the air separation duct is mechanically fixed in the middle of the bow part horizontally along the contour of the ship at different heights of the front part in the water. Each air separation duct, depending on the width of the ship shall be equipped with several air injectors directed in parallel to the slope of the bow part or with a slight deviation in different directions so that the supplied air jets immediately spread over the entire surface of the bow part to suppress the resistance of the water from the front part and in a way that the part of air pass under the ship bottom.

At the bottom of the ship, the air separation duct is installed at the beginning of the keel along the bottom width and the injectors are directed backward so the air could cover the whole surface of the ship bottom from the front part and during the ship travel, the air could be spread over the entire bottom area. If necessary, an air separation duct with injectors can be installed and in other locations along the length of the ship, depending on the length of the ship and the travel speed. At the bottom of the ship and along the sides, there are shallow oval shaped (or of other shapes) air ducts that begin from the front part of the ship and gradually narrow down to the aft side and can continue along the rear side in order to gradually dissipate the air mass along the sides for maintaining the air layer between the ship and the water. The air ducts are of different types and the distance between the ducts is also different.

The ship is built with a wide flat or oval shaped bottom, the bow part of the ship is tilted backwards beginning from the waterline at different angles, and is also wide.

The ship can also be equipped with jet engines that are installed in the bow part of the ship and are connected to air intakes to inject air from the bow of the ship in order to suppress the resistance of the oncoming air and to obtain traction force forward, and the nozzle directs air through the air duct and through the air separation duct by the air injector.

The injectors direct the air jet in front of the ship and under the ship. In front of the ship, the jet is directed into the water sloped downward and backward parallel to the slope of the bow part or with a slight deviation in different directions and in a way the air could cover the entire height and width of the ship in the front, and such that to create an airspace in front of the ship at the moment when the ship enters there with its bow part to remove the resistance of the water.

Air injectors can be installed in front of the ship at different distances from the ship at an elongated air separation duct that is mounted on a metal profile fixed to the bow part of the ship horizontally below the level of the bottom of the ship and protrudes from the ship forward by different lengths, at the end of which the air injectors are fixed in a way that the air jet could be directed backward to the side of the ship under the level of the ship bottom so that the air could rise and reach the level at which the ship is travelling, at that moment when the ship enters there in order to create the low pressure in front of the ship to reduce the water resistance of the front part, at that the pressure of the jet pushes the ship forward.

### BRIEF DESCRIPTION OF THE DRAWINGS

The invention is explained by the following figures:

Fig. No. 1 is a side view of a ship, where:
1—waterline level;
2—rear side;
3—air ducts of the rear side;
4—air duct;
5—air separation duct;
6—air injectors;
7—bow part air injectors;
8—side of the ship;
9—air intakes.

Fig. No. 2 is an underside view of the ship, where:
10—side of the ship above the waterline.

Fig. No. 3 is the type of ship where the outside air ducts are built in the sides of the ship; section “A” shows an embodiment with a corner where:
15—air duct end faces are plugged with caps;
16—air duct (corner).

FIG. 4—view of the ship where the external injectors are installed in one row in the middle of the air separation duct, where:
11—airway duct of the second upper row.

FIG. 5 shows a ship with a rounded duct, with a wide upper part, rear view.

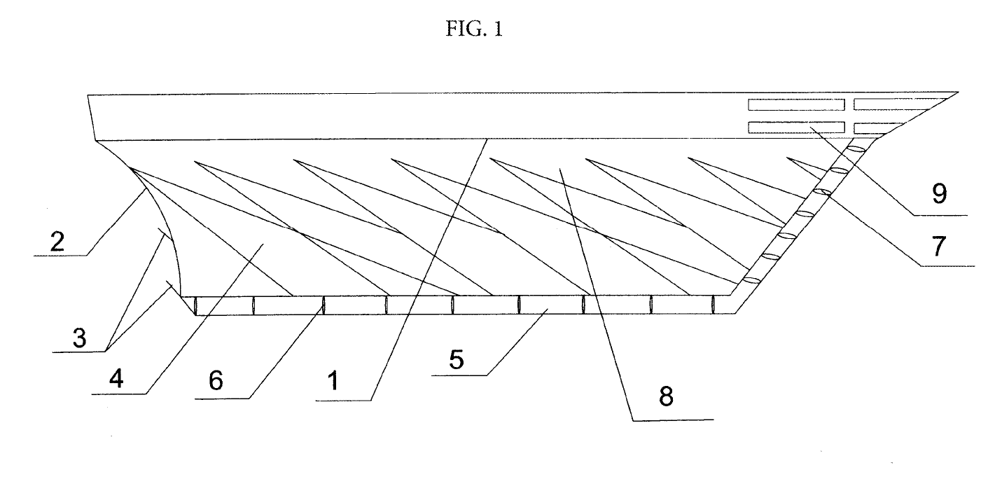

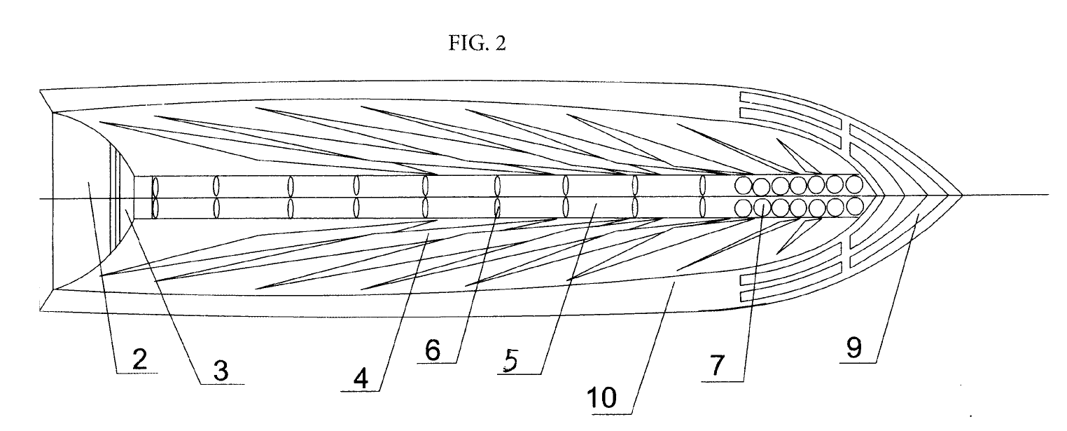

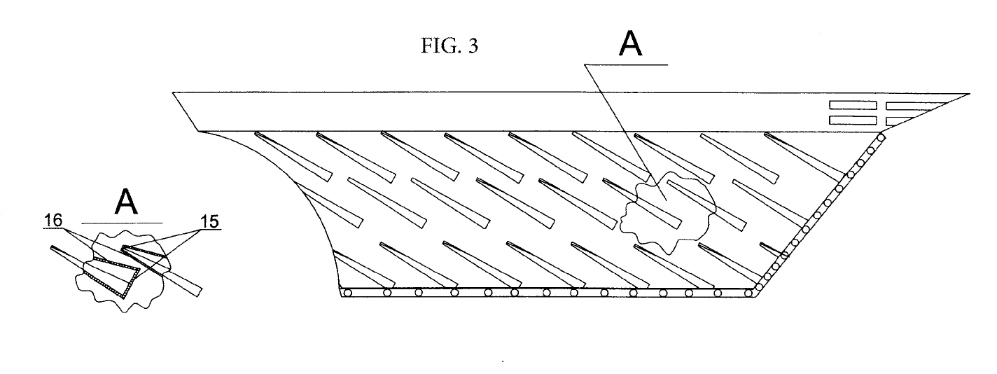

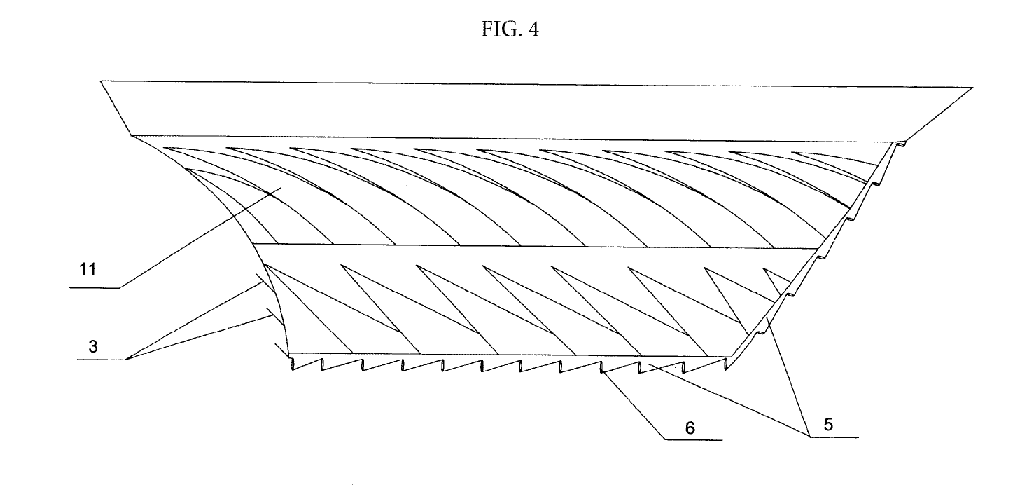

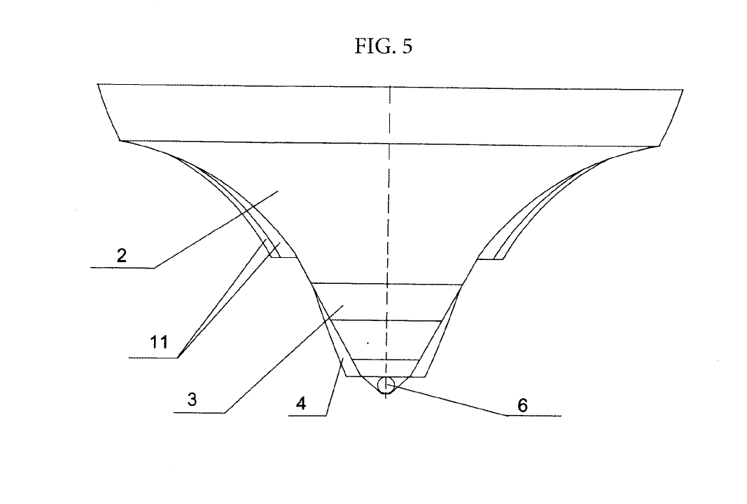

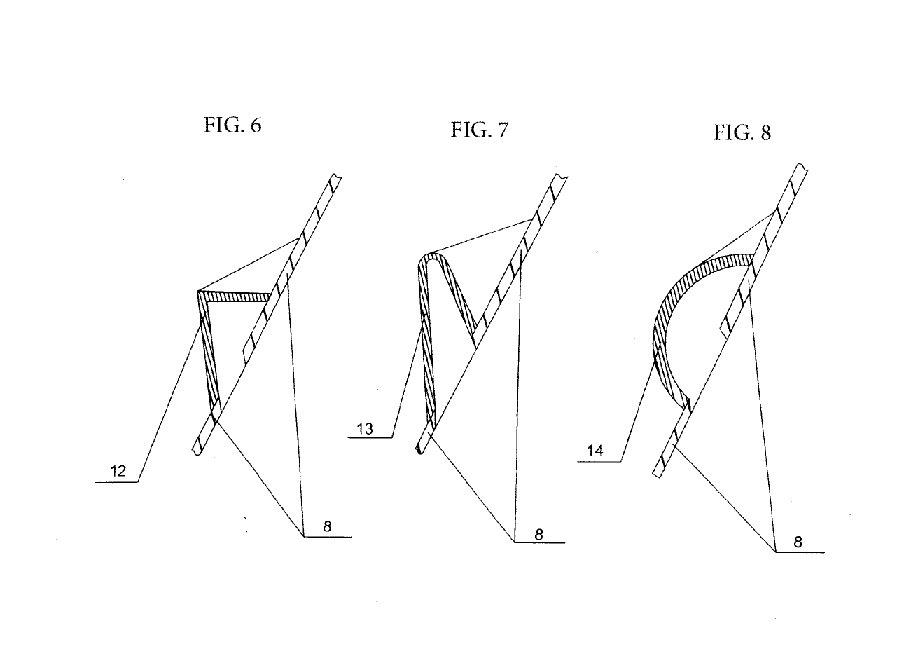

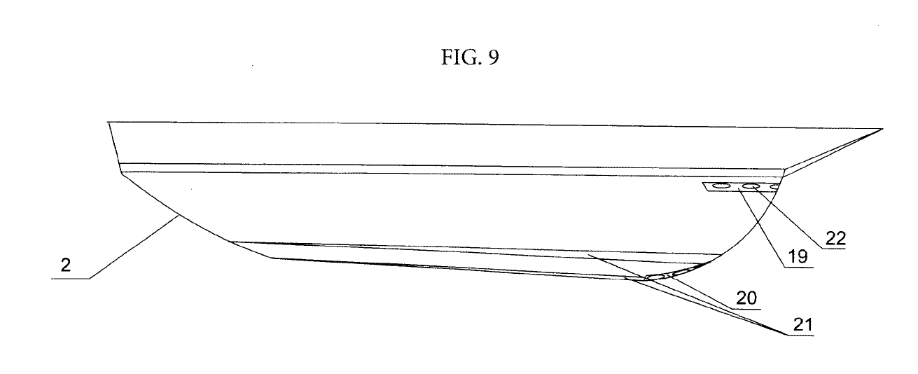

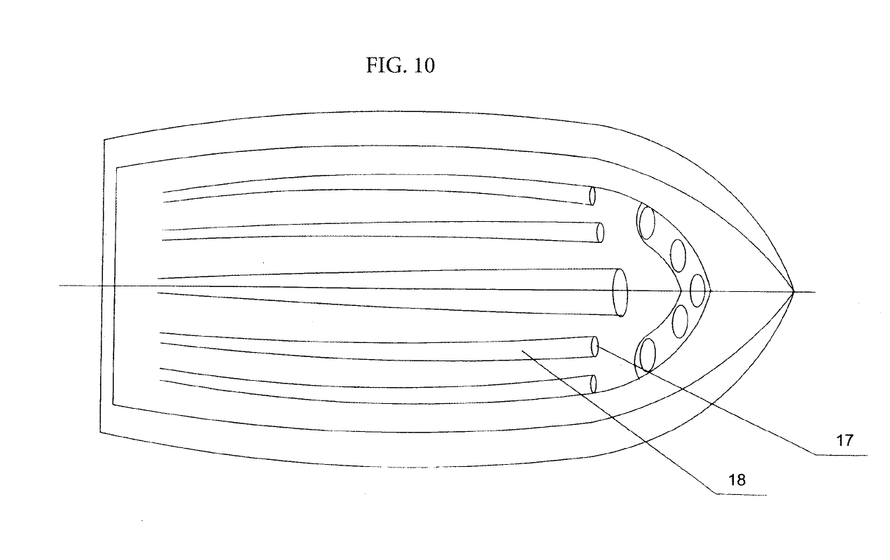

Fig. No. 6, No. 7, No. 8 show three of the multiple possible embodiments of air ducts built into the sides, where:
8—side of the ship, fragment;
12; 13 and 14—are possible embodiments of embedded air ducts.

Fig. No. 9 shows a possible view of a high-speed ship, where
19—horizontal air separation duct for the bow part;
20—horizontal air separation duct for the bottom of the ship; 21—air duct from the bottom of the ship;
22—injectors installed in a horizontal air separation duct.

Fig. No. 10 shows a high-speed ship from underside, where
17—injectors installed in an airway duct;
18—airway duct.

### DETAILED DESCRIPTION OF THE PREFERRED EMBODIMENT

The ship operates as follows:

The started engines provide the operation of air compressors (which are equipped on the ship), which draw the air from the front of the ship through the air intakes 9 and the ship is pulled forward, filling the air receivers (not shown), the control center monitors and regulates the airflow from the receivers through the flow control valves, air passes through air ducts (not shown), air-separation ducts 5 pass and through the injectors 4 the air jet is directed under the ship backward and downward, pushing the ship upwards and forward.

The air injectors 7 in the bow part of the ship direct the air jet into the water downwards and backwards almost in parallel to the slope of the bow part of the ship and push the ship up and forward. Air layers and air-water mass under low pressure occur in front of the ship at its full height and across the width, and the ship is pulled forward. The whole air mass is pressed upwards under the water pressure and enters the air ducts 4 (outside air ducts) that are fixed along the sides of the ship 8 and through the air ducts 4 flows up and back, pushing the ship upward and forward. Along the way along the sides of the ship air in the outer air ducts gradually passes over the sides (as the air ducts narrow) and maintains an air layer between the ship and water.

The ship travels forward and gains on the air mass from the bow part, air from the front of the ship dissipates over the surface of the ship from the bow part entering the air ducts, adding pressure to the ship that moves the ship forward.

Air bubbles and lines appear between the ship and the water and scatter, broke and spread throughout the outer surface of the ship when it travels, and the water resistance decreases to a minimum.

The air rises from the underside and pushes the sloped air ducts of the ship, transferring the force ahead and upward. After that, the air rises frictioning along the sides and pushes the ship upwards. Air pressurized by the water, leaves through the air ducts upward and backward and pushes the ship up and forward. If the air ducts are built into the hull, their resistance to the forward travel is suppressed. In cases of surface mounted outside air ducts, they are installed in a way that the front ones could cover the next ones, resembling the slightly open and turned down fish scales at an angle from one to 89 degrees. The air ducts are installed in that way up to the aft of the ship in order to reduce the resistance, and if there is no distance between the rows, then the upper ones cover the lower ones. A portion of air is supplied under the rear side, and it pushes the ship forward while rising along the slope of the rear side and in the course of travel, when, after passing the sides of the ship the air remaining under water under the water pressure comes under the rear side of the ship in the low pressure zone and rises along the slope of the rear side and adds a push force.

Considering the multiple injectors and external air ducts on the ship and the fact that they are installed at different locations on the ship, the generated pushing force is significant and exists at the entire outer surface of the ship remaining submerged. And by the combination of all forces contributing to the ship travel and the reduced resistance of water and air exerting to the ship, it travels forward and is able to develop the higher speed if compared to the superseded models of ship and provides a possibility to save on fuel.

If the ship is equipped with jet engines, air injection is also performed from the bow part of the ship to suppress the resistance of the oncoming air and to lift the forward traction force, and the air mass is supplied in front of the ship and under the ship sloped backward and downward in order to obtain the pushing force exerting forward and upward for the ship travel and to obtain an air layer between the ship and water and reduce the friction forces between the water with the sides of the ship.

For high-speed ships and barges, the air-separating ducts 19 and 20 are installed at different heights of the ship hull perpendicular to the length of the ship in several rows, depending on the length and speed of the ship, and the injectors 22 and 17 are set in a way to let the air under the ship to be injected along the entire width of the ship bottom and in front of the ship on the entire width of the bow part and in a way to create the airspace in front of the ship at the moment when the ship enters this space and in a way to let the air dissipate along the sides of the ship to the entire length up to the aft part to suppress the resistance from the bow part and from the sides of the ship. The air jet is directed under the ship, backwards or with a slight slope in different directions, depending on the slope of the bottom and through the air ducts 18 air passes backwards and, due to the oval shape of the bottom, passes along the sides and maintains the air layer between the ship and water through the entire area where it passes.

High-speed ship models are built with elongated rear sides and a lower part sloped to the bow part in a way to let the air mass that rises on the rear side push the ship up and forward. The ship can be equipped with an air propeller to increase the speed by any known method and can easily overcome the reduced resistance of water, the ship is fuel efficient.

1. A ship including air compressors, flow control valves, air intakes, receivers, airway ducts, air separation ducts and air injectors, wherein the air separation duct through the airway ducts and the flow control valves is connected to the receivers, the air separation duct is mechanically fixed at a bow part of the ship beginning from a waterline going to a bottom of the ship, and then continues along the bottom of the ship to an aft, and the air injectors are fixed at the air separation duct at different distances from each other depending on a specific situation, so that an air jet is directed backwards or backwards with a slight slope downward to push the ship forward and in a way to let the air to be evenly distributed over two sides of the ship; wherein the air injectors are installed as one row in a middle or as two rows separately for each side, the injectors are designed in a way to let the air rising upward could dissipate and cover an entire area of the sides submerged in the water and create an air layer between the ship and water to reduce the friction between the ship and water surface; wherein the bow part injectors are performed in a way to make it possible to direct the air to create an air space in front at the moment of ship upfloat to reduce a water resistance at the bow part of the ship.

2. The ship according to claim 1, characterized in that the injectors are different in size and can be self-regulating in any known method to change a direction of the injection.

3. The ship according to claim 1, characterized in that the injectors are provided with non-return valves to avoid water penetration into the air separation ducts.

4. The ship according to claim 1, characterized in that, in order to increase an efficiency of an air-displacing force of water, the ship is designed wider than an upper part remaining below the waterline.

5. The ship according to claim 1, characterized in that instead of compressors, the ship is equipped with jet engines where a nozzle is connected to the air separation duct in a way to let exhaust gases through the injectors to be supplied under and in front the ship and the air is pumped in a same way from a front of the ship above the waterline.

6. The ship according to claim 1, characterized in that the air injectors are installed in front of the ship on an elongated air separation duct made of a metal profile of different lengths fixed to a front part of the ship at the end of which the air injectors are fixed in a way to let the air jet to be directed back to the side the ship below a ship bottom level so that the air could rise and reach a level at which the ship travels at a moment when the ship is entering there to create a low pressure in front of the ship at a moment the ship is entering there to reduce a water resistance from the front part of the ship, and a pressure of the jet that presses on the water pushes the ship forward.

7. A ship including air compressors, flow control valves, air intakes, receivers, airway ducts, air separation ducts and air injectors, wherein the air separation duct through airway ducts and flow control valves is connected to the receivers, the air separation duct is mechanically fixed on sides of the ship, on a bow part of the ship and at a ship bottom transversally to a length of the ship and in horizontal plane, several rows at different heights of the submerged part of the ship hull, several air injectors are mechanically fastened on the air-separation duct depending on the breadth of the ship, several air injectors are directed parallel to a downward slope of the bow part of the ship and backward in different order and direction depending on a specific site of their installation, the injectors are self-adjustable and are installed on the air separation duct in a way to let the air to be supplied in front of the ship and under the ship along a whole width at once, and in any case are directed backwards or with a slight slope in different directions, in a way to let the air jet to push the ship forward or forward and upward, the bow part and the oval bottom of the ship are wide and flattened, the bow part of the ship is sloped backward beginning from a waterline at different angles and the bottom is sloped upward at different angles starting from the front at different points along the length of the ship in a way to let the air along the bottom retreat and push the ship forward; the ship bottom can also be sloped downwards starting from the bow part at different angles so that at a speed the ship could travel supported by an air cushion upward and forward, in this case a rear side is extended from the bottom to the side and forward in a way to let the air up along the rear side to pressed the rear side and push the ship forward and upward.

8. The ship according to claim 7, characterized in that there are shallow airway ducts at the bottom and along the sides of the ship, which gradually narrow from the front to an aft part, so that an air mass gradually dissipates along the sides to maintain an air layer between the ship and a water surface, the airway ducts can be of different types and a distance between the airway ducts is also different.

9. A ship including air compressors, flow control valves, air intakes, receivers, airway ducts, air separation ducts and air injectors, wherein the air separation duct through the airway ducts and the flow control valves is connected to the receivers, the air separation duct is mechanically fixed in a bow part of the ship, beginning from a waterline and to a ship bottom, and then the air separation duct continues along the bottom of the ship to an aft, and the air injectors are fixed at the air separation duct at different distances from each other depending on a specific situation so that the air jet could be directed backwards or backwards with a slight slope downward to push the ship forward and in a way the air can be evenly distributed along two sides of the ship and the airway ducts are fixed on the sides of a watercraft to let the air along the airway ducts to pass backwards and upwards; wherein the airway duct is performed as a flat metal triangle or other shape and is mechanically fixed on the sides of the ship from an upper side or from the upper and a front sides, depending on the shape and location, sloped downwards for form the airway duct by a flattened metal and a hull side, and in a way to make a back side of the airway duct higher so the air would go up and back in the airway duct to push the ship forward, wherein the airway ducts are made in shape of a metal corner or as other shaped profile and are embedded in the sides of the ship from inside, and there is an opening of a rectangular or triangular shape cut in the hull side so the air rise from the bottom of the ship and enter a slot in the sides and along the airway ducts fixed to the sides on the inside could pass up and back, at that the airway ducts are narrowed beginning from a front lower part so the air passing backwards could gradually pass through sides of the airway duct to maintain an air layer between the ship and the water, wherein the airway ducts along a width and a length are different, an angle between a flat metal and the hull side, the slope of the airway ducts from a horizontal plane is different and shall be calculated individually for each ship; wherein in cases a surface mounted external airway ducts are used, they are installed in a way first ones cover next ones up to the aft part, resembling a semi-open and sloped down fish scales, wherein the airway ducts may be of a different profile, and on the sides of the ship are installed in horizontal rows, on a different distance between rows, wherein the air duct can also overlap each other.

10. The ship according to claim 9, characterized in that the airway ducts are mechanically fixed to a rear side horizontally, or the ship shall be designed in a way that the rear side has an appropriate slope so that the air could press on it and flow back, and the ship could travel forward, the slope of air outlets on the rear side is different, the air outlets can be hinge mounted and to be adjusted depending on a speed of the ship by any known method.

11. The ship of claim 9 is characterized in that it is made of a suitable profile, where there are already airway ducts for passing air upward and downward through them.

12. A ship including air compressors, flow control valves, air intakes, receivers, airway ducts, air separation ducts and air injectors, wherein the air separation duct through airway ducts and the flow control valves is connected to the receivers, the air intakes are connected to the compressor via the airway ducts; the air intakes are installed along sides of a bow ship above water line so that the air is pumped from a front of the ship, to remove a resistance of the oncoming air and get forward traction, the air intakes are of a known form, and the air intakes are installed in different orders along the sides so as to cover an entire volume of a counter air flow at any speed of the ship.
